(19) United States
(12) Patent Application Publication
(10) Pub. No.: US 2022/0297507 A1
(43) Pub. Date: Sep. 22, 2022

(54) DEFROSTER STRUCTURE

(71) Applicant: HONDA MOTOR CO., LTD., Tokyo (JP)

(72) Inventors: Toru OKINAGA, Tokyo (JP); Eishi KOBAYASHI, Tokyo (JP)

(21) Appl. No.: 17/668,928

(22) Filed: Feb. 10, 2022

(30) Foreign Application Priority Data
Mar. 19, 2021 (JP) 2021-045679

(51) Int. Cl. B60H 1/24; B60H 1/34; B60H 1/00

(52) U.S. Cl. CPC B60H 1/241; B60H 1/3407; B60H 1/00271; B60H 1/0055; B60H 1/00564; B60H 2001/2287

(57) ABSTRACT

A defroster structure includes: a window panel; an instrument panel; an air outlet member formed with an opening through which defrost air is blown out; and a duct member. The air outlet member includes an adjacent part forming a front edge of the opening and adjacent to the window panel, and a fixed part continuous to the adjacent part. The fixed part is fixed to the duct member at a position in front of a front end part of the window panel, which is exposed to the vehicle compartment, in cross-sectional view in a front-rear direction.

### CROSS-REFERENCE TO RELATED APPLICATION

The present application claims the benefit of priority to Japanese Patent Application No. 2021-045679 filed on Mar. 19, 2021, the disclosures of all of which are hereby incorporated by reference in their entireties.

### TECHNICAL FIELD

The present disclosure relates to a defroster structure provided in a vehicle.

### BACKGROUND

A vehicle is provided with a defroster which blows out air toward an interior surface of a window panel, in a predetermined direction, to prevent fogging on the window panel and the like. For example, Japanese Patent Application Publication No. 2012-1486686 discloses an outlet for defrost air arranged on an upper surface of an instrument panel along a lower edge of the window panel.

Meanwhile, the number of electrical components mounted under the instrument panel has increased in recent years, and a larger space is required to arrange the electrical components therein. If the outlet for defrost air is moved to an edge of the instrument panel, a large space can be secured. Further, an image of the outlet for defrost air is reflected on the window panel and comes into front view of occupants. If the air outlet is moved forward, a position of the image comes closer to the lower edge of the window panel so that a good field of view is widely secured. Thus, from a viewpoint of increasing electrical components in number and securing visibility, an outlet for defrost air is desired to be moved forward.

In a case where an outlet for defrost air is arranged on the instrument panel, a defroster outlet member may separately be prepared from an instrument panel member and fitted into an opening in the instrument panel member. The defroster outlet member is fixed to the instrument panel member by means of resin claws or the like. However, in consideration of strength of the instrument panel and strength of the defroster outlet member being attached, the defroster outlet member is surrounded by the instrument panel member so as to be fixed in place. Therefore, as shown in FIG. 5, for example, a front part 200A of an instrument panel member 200 is required in front of a defroster outlet member 300, to have a limitation for an outlet for defrost air in moving forward.

The present disclosure is intended to solve such a problem, and provides a defroster structure in which an outlet for defrost air is arranged at a position on, and in vicinity to a window panel in front of, an instrument panel, while strength of an instrument panel and strength of a defroster outlet member being attached are secured.

### SUMMARY

To solve the problem described above, a defroster structure of the present disclosure includes: a window panel arranged at a front in a vehicle compartment; an instrument panel extending rearward in the vehicle compartment from the window panel; an air outlet member arranged in the instrument panel and formed with an opening through which defrost air is blown out to the window panel; and a duct member arranged under the instrument panel and forming a path to supply the defrost air to the opening, wherein the air outlet member includes an adjacent part forming a front edge of the opening and adjacent to the window panel, and a fixed part continuous to the adjacent part, and the fixed part is fixed to the duct member at a position in front of a front end part of the window panel, which is exposed to the vehicle compartment, in cross-sectional view in a front-rear direction.

According to the present disclosure, an outlet for defrost air can be arranged at a position on, and in vicinity to a window panel in front of, an instrument panel, while strength of the instrument panel and strength of the defroster outlet member being attached are secured.

### BRIEF DESCRIPTION OF THE DRAWINGS

FIG. 1 is an end view of a defroster structure according to an embodiment, taken along a line I-I in FIG. 2;

FIG. 2 is a top view of a part of the defroster structure according to the embodiment;

FIG. 3A is a perspective view of the defroster structure in FIG. 2, with an air outlet member taken out;

FIG. 3B is a top view of the defroster structure in FIG. 2, without the air outlet member;

FIG. 4 is a bottom view of the defroster structure of the embodiment, partly attached with an insulator member; and

FIG. 5 is a top view of a conventional defroster structure.

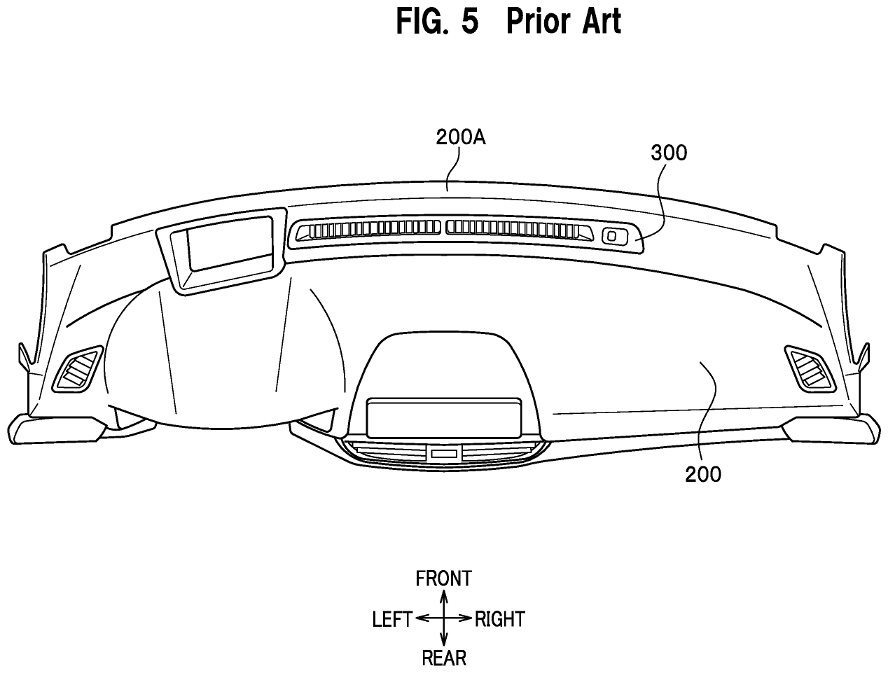

### DETAILED DESCRIPTION

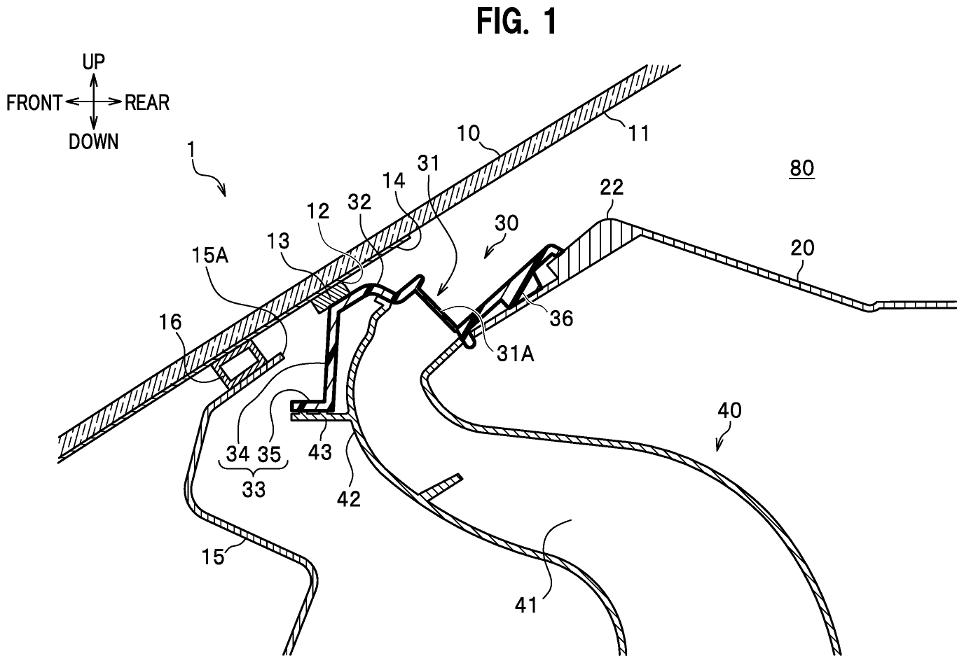

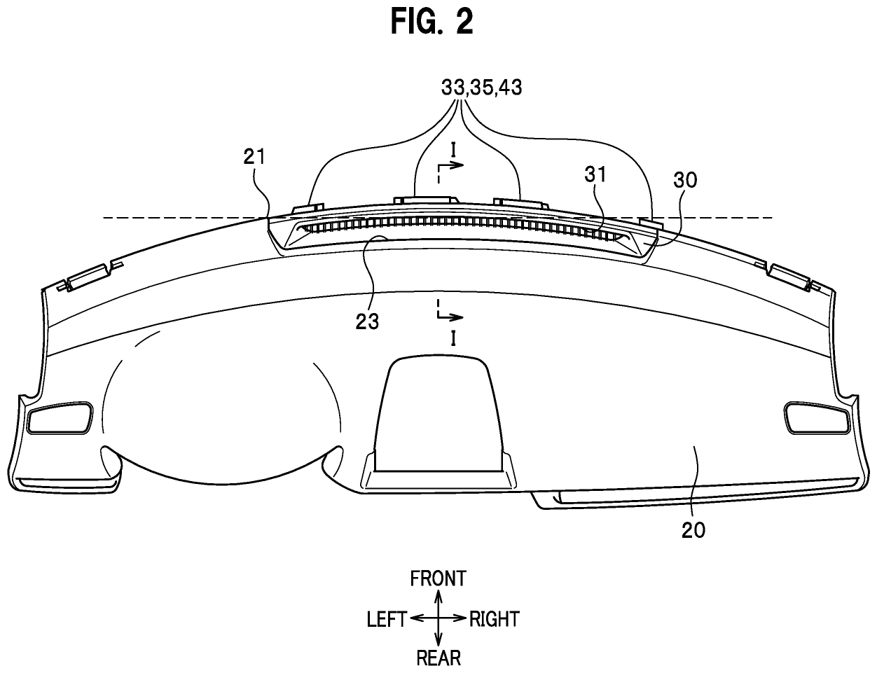

A description is given of an embodiment of the present disclosure with reference to the drawings. As shown in FIGS. 1 and 2, a defroster structure 1 of the embodiment blows out defrost air through an opening 31 in an instrument panel 20 to defrost a window panel 10. The opening 31 is formed in an air outlet member 30, which is a separate member from the instrument panel 20, and the air outlet member 30 is arranged in the instrument panel 20. Defrost air is supplied through a path formed by a duct member 40. Note that FIG. 2 is a top view of the instrument panel 20 and the air outlet member 30 as a part of the defroster structure 1 according to the embodiment. FIG. 1 shows an enlarged front part of the defroster structure 1, as an end view of the structure taken along a line I-I in FIG. 2.

### Window Panel

The window panel 10 is a plate-shaped member provided at a front window of a vehicle compartment 80. The window panel 10 is arranged to incline downward from rear to front. Further, the window panel 10 is curved in a vehicle width direction so as to protrude forward.

An upper part of a surface 11 of the window panel 10, inside the vehicle compartment 80 and above a front end part 12 as a boundary, is exposed to the vehicle compartment 80. The front end part 12 is positioned on the surface 11 at an upper end of a sealing member 13. The sealing member 13 is arranged in a gap between the window panel 10 and a component in the vehicle compartment 80 and is made of urethane foam, for example. In FIG. 1, the window panel 10 and the air outlet member 30 (described below) are adjacent to each other via the sealing member 13. A part of a ceramic zone 14 coated with black ceramic or the like is exposed to the vehicle compartment 80 above the sealing member 13 of the surface 11. The ceramic zone 14 is provided in an area under the part exposed to the vehicle compartment 80, to extend end to end in a right-left direction of the window panel 10. The front end part 12 is located anterior to an upper end of the ceramic zone 14.

The window panel 10 is supported by a window panel support member 15 (described below), at a position lower than the front end part 12, that is, at a position not exposed to the vehicle compartment 80.

### Instrument Panel

The instrument panel 20 is a member which serves as a front wall surface of the vehicle compartment 80. The instrument panel 20 extends from the window panel 10 rearward in the vehicle compartment 80. The duct member 40 to be described below, electrical components, and the like are arranged below the instrument panel 20.

As shown in FIG. 1, the instrument panel 20 has an upwardly inclined surface as extending forward and a downwardly inclined surface as extending forward from an upper end of the upwardly inclined surface, to form a mountain shape having a top 22 in cross section. With the mountain shape, the air outlet member 30 can be arranged at a position where occupants can hardly see.

As shown in FIG. 2, the air outlet member 30 is arranged such that the instrument panel 20, when viewed from above, has the opening 31 located inside an attachment part 23, which is formed to cut out a front end thereof in a substantially trapezoidal shape. Here, a front end of the instrument panel 20 and a front end of the air outlet member 30 are continuous to each other, so as to form a convex forward curve. On right and left sides of the air outlet member 30, the front end of the instrument panel 20 is adjacent to the window panel 10. Accordingly, the sealing member 13 mentioned above is arranged in the gap between the window panel 10 and the instrument panel 20 or air outlet member 30, from the left end to the right end of the vehicle compartment 80. Note that the front end of the instrument panel 20 and front end of the air outlet member 30 may be continuous to each other so as to form a straight line.

### Duct Member

The duct member 40 forms the path for supplying defrost air. The duct member 40 has a hollow air flow path 41 which serves as the path for defrost air and is arranged under the instrument panel 20. The air flow path 41 of the duct member 40 is connected to the air outlet member 30. A front wall 42 located at a front end of the air flow path 41 is provided with extensions 43 extending forward.

### Air Outlet Member

The air outlet member 30 is a member to form an outlet for defrost air. The air outlet member 30 includes the opening 31, an adjacent part 32, fixed parts 33, and a rear edge part 36. As shown in FIG. 2, the two or more (four in this case) fixed parts 33 are provided at a front of the air outlet member 30.

Defrost air is blown out through the opening 31. Here, as shown in FIG. 1, the opening 31 is directed slightly rearward rather than right above, and a cover 31A is arranged therein. The cover 31A is a grid-shaped member, for example.

The adjacent part 32 forms a front edge of the opening 31 and is adjacent to the window panel 10 at a front end thereof. Here, the adjacent part 32 forms a downwardly inclined surface as extending forward from the front edge of the opening 31, is bent at a lower end of the inclined surface to extend forward, and comes in contact with the sealing member 13 at the front end thereof.

The fixed parts 33 are formed to continue to the front end of the adjacent part 32. The fixed parts 33 are fixed to the duct member 40 at positions ahead of the front end part 12 of the window panel 10, in longitudinal cross sections taken along a front-rear direction at respective positions in the vehicle width direction of the fixed parts 33. Further, the fixed parts 33 are fixed to the duct member 40 at positions ahead in the front-rear direction of the upper end of the ceramic zone 14, in the longitudinal cross sections taken along the front-rear direction at respective positions in the vehicle width direction of the fixed parts 33.

As shown in FIG. 2, when viewed from above, three out of the four fixed parts 33 are fixed to the duct member 40 at positions in front of a frontmost end 21 of the instrument panel 20. At least a part of the fixed parts 33 may be fixed to the duct member 40 at a position in front of the frontmost end 21 of the instrument panel 20.

The fixed parts 33 each has a protruding section 35 protruding more forward than the adjacent section 32. Here, the fixed part 33 has an extending section 34, which is a wall surface extending downward from the front end of the adjacent part 32, and the protruding section 35 is formed to extend forward from a lower end of the extending section 34.

The fixed parts 33 are provided near the right and left ends and near the center of the air outlet member 30, so that the air outlet member 30 is stably fixed. Here, the four fixed parts 33 (protruding sections 35) are provided, one at each of the positions near the right and left ends and two near the center. The protruding sections 35 near the center each has a wider width in the right-left direction to further increase stability. The protruding sections 35 are each fixed to an upper surface of the extension 43 by vibration welding. Note that a clip, a nail, a screw, adhesive, or the like may alternatively be used for fixing.

As shown in FIG. 1, the rear edge part 36 forms a rear edge of the opening 31 and an inclined surface extending rearward and upward from the rear edge of the opening 31. A periphery of the rear edge part 36 is arranged to overlap the instrument panel 20 from above. The rear edge part 36 is continuous to the adjacent part 32 via a lateral edge part. The lateral edge part forms a lateral edge of the opening 31, and a periphery thereof is arranged to overlap the instrument panel 20 from above, as with the rear edge part 36.

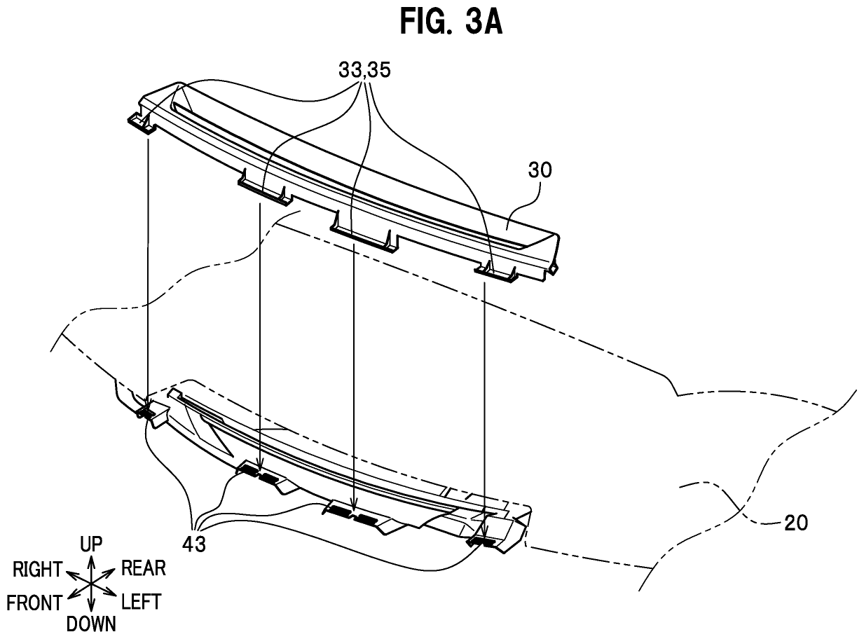

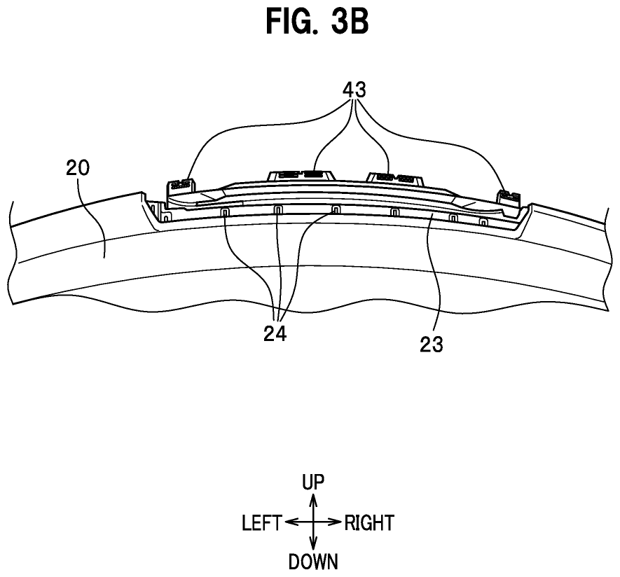

FIG. 3A is a perspective view of the defroster structure 1, with the air outlet member 30 taken out. In addition to fixing the fixed parts 33 of the air outlet member 30 to the duct member 40, the lateral edge or the rear edge of the opening 31 may be also fixed to the instrument panel 20.

With the additional fixing to the instrument panel 20, rigidity of the instrument panel 20 can be increased at the front end. A clip, a nail, a screw, adhesives, or the like may be used for fixing. For example, as shown in FIG. 3B, in clip fixing, the attachment part 23 of the instrument panel 20 is formed with clip insertion holes 24, into which protrusions formed in the air outlet member 30 are inserted for fixing.

For example, when clip fixing is employed, after the instrument panel 20, to which the air outlet member 30 is fixed by clip fixing, has been attached to the duct member 40, the protruding sections 35 are fixed to the extensions 43 by vibration welding or the like. Also, after the instrument panel 20 has been attached to the duct member 40, the air outlet member 30 may be fixed to the instrument panel 20 by clip fixing, and the protruding sections 35 may be fixed to the extensions 43 by vibration welding or the like. Note that the air outlet member 30 may be fixed only by the protruding sections 35 (fixed parts 33).

### Window Panel Support Member

As shown in FIG. 1, the window panel support member 15 supports the window panel 10 from behind at a position in front of and below the adjacent part 32. The window panel support member 15 has a lower part thereof supported at a position (not shown), extends upward, and supports the window panel 10 in vicinity to an upper end 15A thereof, via a contact member 16.

The window panel support member 15 is bent to protrude forward, so as to surround a front side of the extensions 43 and the protruding sections 35, and the upper end 15A is located above the protruding sections 35.

### Insulator Member

An insulator member 50 is a sheet-shaped member arranged between an engine compartment at the front and the vehicle compartment 80 for the purpose of sound and vibration isolation.

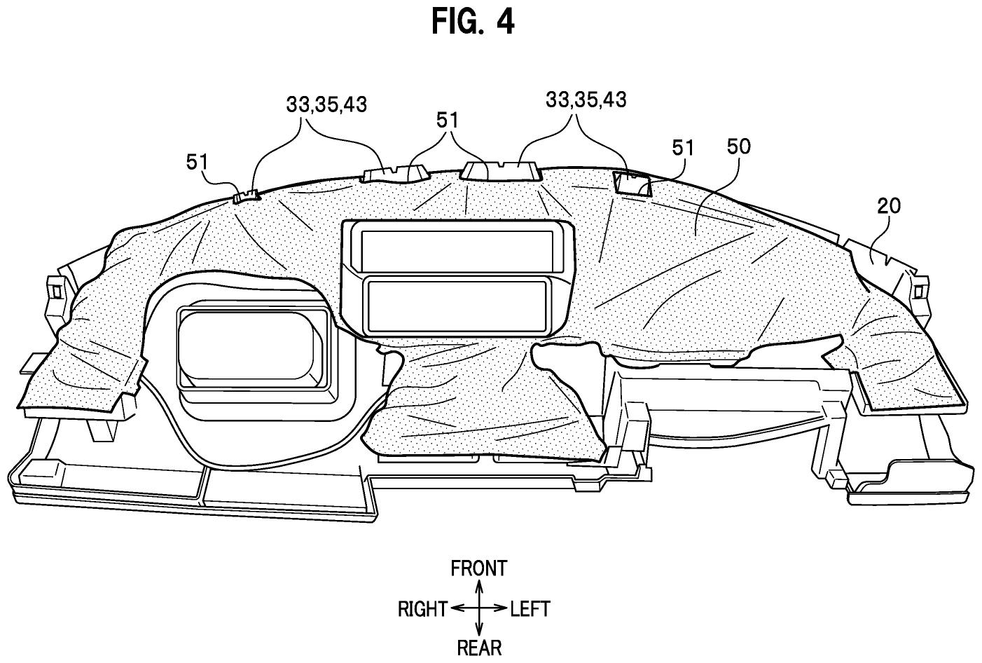

The insulator member 50 is attached to lower parts of the duct member 40 and the air outlet member 30, under the instrument panel 20. FIG. 4 shows a bottom view of the attached insulator member 50. As shown in FIG. 4, the insulator member 50 has engagement holes 51 to be hooked on and supported by the protruding sections 35 fixed to the extensions 43.

The defroster structure 1 of the present disclosure is basically configured as described above. Next, a description is given of advantageous effects of the defroster structure 1.

The defroster structure 1 of the present disclosure includes: the window panel 10 arranged at a front in the vehicle compartment 80; the instrument panel 20 extending rearward in the vehicle compartment 80 from the window panel; the air outlet member 30 arranged in the instrument panel 20 and formed with the opening 31 through which defrost air is blown out to the window panel 10; and the duct member 40 arranged under the instrument panel 20 and forming the path to supply the defrost air to the opening 31. The air outlet member 30 includes the adjacent part 32 forming the front edge of the opening 31 and adjacent to the window panel 10, and the fixed parts 33 continuous to the adjacent part 32. The fixed parts 33 are fixed to the duct member 40 at positions in front of the front end part 12 of the window panel 10, which is exposed to the vehicle compartment 80, in cross-sectional view in the front-rear direction.

According to the configuration, the air outlet member 30 formed with the opening 31, through which defrost air is blown out to the window panel 10, is arranged in the instrument panel 20. Components around the opening 31 can be separated from the instrument panel 20. This allows for easily adjusting a shape of the opening 31 and the like. The air outlet member 30 includes the adjacent part 32 forming the front edge of the opening 31 and adjacent to the window panel 10, and the fixed parts 33 continuous to the adjacent part 32. The fixed parts 33 are fixed at positions in front of the front end of the window panel 10 exposed to the vehicle compartment 80, in cross-sectional view taken along the front-rear direction. This allows the air outlet member 30 to be provided at a position on, and in vicinity to the window panel 10 in front of, the instrument panel 20. Accordingly, a large space can be secured behind the air outlet member 30, under the instrument panel 20. In addition, an image of the air outlet member 30, which is reflected on the window panel 10 and comes into view of occupants, especially, an image of the opening 31 is positioned at the lower edge of the window panel 10 in the vehicle compartment 80, so that a good field of view is secured. This improves visibility at the time of driving.

Further, the fixed parts 33 are fixed to the duct member 40 arranged under the instrument panel 20 so that the air outlet member 30 having the opening 31 can be fixed directly to the duct member 40, to allow for stabilizing a positional relationship between the air outlet member 30 and the duct member 40.

The defroster structure 1 of the present disclosure includes: the window panel 10 arranged at a front in the vehicle compartment 80; the instrument panel 20 extending rearward in the vehicle compartment 80 from the window panel 10; the air outlet member 30 arranged in the instrument panel 20 and formed with the opening 31 through which defrost air is blown out to the window panel 10; and the duct member 40 arranged under the instrument panel 20 and forming the path to supply the defrost air to the opening 31. The air outlet member 30 includes the adjacent part 32 forming the front edge of the opening 31 and adjacent to the window panel 10, and the fixed parts 33 continuous to the adjacent part 32. At least a part of the fixed parts 33 is fixed to the duct member 40 at a position in front of the frontmost end 21 of the instrument panel 20.

According to the configuration, the air outlet member 30 formed with the opening 31, through which defrost air is blown out to the window panel 10, is arranged in the instrument panel 20. Components around the opening 31 can be separated from the instrument panel 20. This allows for easily adjusting a shape of the opening 31 and the like. The air outlet member 30 includes the adjacent part 32 forming the front edge of the opening 31 and adjacent to the window panel 10, and the fixed parts 33 continuous to the adjacent part 32. At least a part of the fixed parts 33 is fixed at a position in front of the frontmost end 21 of the window panel 10. This allows the air outlet member 30 to be provided at a position on, and in vicinity to the window panel 10 in front of, the instrument panel 20. Accordingly, a large space can be secured behind the air outlet member 30, under the instrument panel 20. In addition, an image of the air outlet member 30, which is reflected on the window panel 10 and comes into view of occupants, especially, an image of the opening 31 is positioned at the lower edge of the window panel 10 in the vehicle compartment 80, so that a good field of view is secured. This improves visibility at the time of driving.

Further, the fixed parts 33 are fixed to the duct member 40 arranged under the instrument panel 20 so that the air outlet member 30 having the opening 31 can be fixed directly to the duct member 40, to allow for stabilizing a positional relationship between the air outlet member 30 and the duct member 40.

In the defroster structure 1 of the present disclosure, the fixed parts 33 is preferably fixed to the duct member 40 by vibration welding.

Using vibration welding allows the fixed parts 33 to have smaller volume than a case of screw fixing or the like, so that interference with other components can be reduced and locations for fixing the fixed parts 33 can be secured efficiently.

In the defroster structure 1 of the present disclosure, the fixed parts 33 each preferably has the protruding section 35 protruding more forward than the adjacent part 32.

According to the configuration of the fixed parts 33 having the protruding sections 35, protruding more forward than the adjacent part 32, locations for fixing the fixed parts 33 can be secured stably in front of the adjacent part 32.

Preferably, the defroster structure 1 of the present disclosure is further provided with the window panel support member 15 to support the window panel 10 in front of and below the adjacent part 32, and the upper end 15A of the window panel support member 15 is positioned above the protruding sections 35.

According to the configuration of the upper end 15A of the window panel support member 15 being positioned above the protruding sections 35, a space below the upper end 15A can be effectively used to arrange the protruding sections 35 therein. Therefore, there is no need to change a supporting position of the window panel support member 15 for the window panel 10. Thus, locations for fixing the protruding sections 35 can be secured while stability of support by the window panel support member 15 is maintained.

Preferably, the defroster structure 1 of the present disclosure is further provided with the insulator member 50 attached to the lower parts of the duct member 40 and the air outlet member 30, and at least a part of the insulator member 50 is hooked on and supported by the protruding sections 35.

According to the configuration of at least a part of the insulator member 50 being hooked on and supported by the protruding sections 35, there is no need to provide a dedicated shape or the like for attaching the insulator member 50, to allow for reducing the number of components and saving space.

Preferably, in the defroster structure 1 of the present disclosure, the fixed parts 33 each has the extending section 34 extending downward from the adjacent part 32 and the protruding section 35 extending forward from the lower end of the extending section 34, the duct member 40 has the front wall 42 provided on the front end of the duct member 40 and the extensions 43 extending forward from the front wall 42, and the protruding sections 35 are fixed to the upper surfaces of the extensions 43.

According to the configuration of the fixed parts 33 each having the extending section 34, extending downward from the adjacent part 32, and the protruding section 35, extending forward from the lower end of the extending section 34, a height at which the protruding part 35 is located can be adjusted. The duct member 40 having the front wall 42, provided on the front end of the duct member 40, and the extensions 43, extending forward from the front wall 42, with the protruding sections 35 fixed to the upper surface of each extension 43, allows the extension 43 to be provided at a position aligned with the protruding section 35 for fixing the protruding section 35. Therefore, the space under the upper end 15A of the window panel support member 15 can be used more effectively to arrange therein, and to secure locations for fixing, the protruding sections 35.

The defroster structure 1 of the present embodiment has been described above, but the present disclosure is not limited thereto and may be modified within the scope of the present disclosure.

For example, the number of the fixed parts 33 is four in the present embodiment, but may be three or less, or five or more. In addition, widths of the respective fixed parts 33 may be smaller or larger. The fixed parts 33 may be connected to one another in one piece in the vehicle width direction. In a case where the widths of the fixed parts 33 are larger, a part thereof in the vehicle width direction may be fixed to the duct member 40 at a position in front of the frontmost end 21 of the instrument panel 20.

Further, for example, in the present embodiment, the case where the instrument panel 20 and the front end of the air outlet member 30 are curved has been described as an example. However, the instrument panel 20 and the front end of the air outlet member 30 may be continuous to form a straight shape. In this case, the entire fixed parts 33 are fixed to the duct member 40 at positions in front of the frontmost end 21 of the instrument panel 20.

What is claimed is:

1. A defroster structure comprising:
a window panel arranged at a front in a vehicle compartment;
an instrument panel extending rearward in the vehicle compartment from the window panel;
an air outlet member arranged in the instrument panel and formed with an opening through which defrost air is blown out to the window panel; and
a duct member arranged under the instrument panel and forming a path to supply the defrost air to the opening, wherein
the air outlet member includes an adjacent part forming a front edge of the opening and adjacent to the window panel, and a fixed part continuous to the adjacent part, and
the fixed part is fixed to the duct member at a position in front of a front end part of the window panel, which is exposed to the vehicle compartment, in cross-sectional view in a front-rear direction.

2. A defroster structure comprising:
a window panel arranged at a front in a vehicle compartment;
an instrument panel extending rearward in the vehicle compartment from the window panel;
an air outlet member arranged in the instrument panel and formed with an opening through which defrost air is blown out to the window panel; and
a duct member arranged under the instrument panel and forming a path to supply the defrost air to the opening, wherein
the air outlet member includes an adjacent part forming a front edge of the opening and adjacent to the window panel, and fixed parts continuous to the adjacent part, and
at least a part of the fixed parts is fixed to the duct member at a position in front of a frontmost end of the instrument panel.

3. The defroster structure as claimed in claim 1, wherein the fixed part is fixed to the duct member by vibration welding.

4. The defroster structure as claimed in claim 1, wherein the fixed part has a protruding section protruding more forward than the adjacent part.

5. The defroster structure as claimed in claim 4 further comprising a window panel support member to support the window panel at a position in front of and below the adjacent part, wherein an upper end of the window panel support member is located above the protruding section.

6. The defroster structure as claimed in claim 4 further comprising an insulator member attached to lower parts of the duct member and the air outlet member, wherein at least a part of the insulator member is hooked on and supported by the protruding section.

7. The defroster structure as claimed in claim 4, wherein
the fixed part has an extending section extending downward from the adjacent part and the protruding section extending forward from a lower end of the extending section,
the duct member has a front wall provided on a front end of the duct member and an extension extending forward from the front wall, and
the protruding section is fixed to an upper surface of the extension.
